(19) United States
(12) Patent Application Publication
(10) Pub. No.: US 2004/0173521 A1
(43) Pub. Date: Sep. 9, 2004

(54) Filter material, filter body and method of manufacturing a filter material

(76) Inventor: Peter Wirtz, Duren (DE)

Correspondence Address: WILLIAM COLLARD, COLLARD & ROE, P.C., 1077 NORTHERN BOULEVARD, ROSLYN, NY, 11576, US

(21) Appl. No.: 10/738,424

(22) Filed: Dec. 17, 2003

(30) Foreign Application Priority Data
Dec. 18, 2002 (DE) 102 59 654.9

(51) Int. Cl. B01D 29/00

(52) U.S. Cl. 210/490; 210/496; 210/499; 210/500.1

(57) ABSTRACT

In order to develop a filter material composed of stacked grid members, the invention proposes a filter material consisting of two stacked grid members that have a weld joint between them.

The invention relates on the one hand to a filter material consisting of two stacked grid members and to a filter body and on the other hand to a method of manufacturing a filter material consisting of several grid members.

Filter materials consisting of two stacked grid members are known in the art in a great variety of ways. In order to bond the individual grid members together over a large surface, the individual grid members are sintered batchwise over a quite long period of time. The individual grid elements are thereby intimately bonded together in their regions of mutual contact so that the grid elements are reliably bonded to form a multilayered filter material.

The disadvantage of filter materials manufactured according to sintering is that sintering of the grid members is only carried out batchwise, which makes it quite complicated. Another drawback is that a sinter bond requires large contact areas to ensure a sufficiently strong bond between the individual components. In the case of the grid members, this however means that the sinter bond occupies large areas of the grid members which are not available for use as filter areas.

It is the object of the invention to eliminate the disadvantages of the known filter materials and to develop said filter materials.

The object of the present invention is solved by a filter material consisting of two stacked grid members that are bonded together by a weld joint.

In contrast to prior opinion, the present inventors were able to weld two grid members together in such a manner that the actual grid structure of the grid members will hardly be destroyed in the welding process so that the filter function of the filter material of the invention will not be negatively affected. Moreover, it has been found that localized welding of the individual grid members suffices to provide a strong bond between the various grid members. Localized welding permits on the one side to increase the serviceable filter area and on the other side to provide a greater degree of flexibility in forming the filter material of the invention as compared to conventional filter material.

The term “filter material” is to be construed herein as any material that is permeable to a certain degree or that has a surface structured in a particular way so as to be capable of performing a filter function. However, the invention also covers materials which, although they have a similar appearance, are not used for filtration. Such type of materials are used as wall elements, linings, wind brakes or with regard to their acoustic properties.

By “grid member” a material is meant which, due to its structure, has a certain porosity.

The term “weld joint” hereby includes bonding processes by which, in contrast to the sintering process, a material is heated above its melting point and materials heated to melting point melt together in their area of melting. Hitherto, the materials of such type grid members were just less heated in a sintering process than in a welding process.

The possibility of welding the grid members together to form a filter material using a welding process allows for welding the grid members together to form a length of material, the actual filter material being a length of material, the length of which is in excess of six meters, preferably in excess of twelve meters. More specifically, the grid members can be welded together to form a filter material of any length e.g., of a length of twenty meters.

Accordingly, it is now possible to manufacture a filter material consisting of stacked grid members in the way of a continuous length of material so that a batchwise filter material manufactured by sintering may be dispensed with. Considerable economical advantages derive therefrom since it is far less expensive to manufacture a filter material consisting of two or more grid members that are welded together.

In order to allow manufacturing of filter bodies from the filter material in a variety of ways, it is advantageous to provide a length of material having a width in excess of 0.5 m, preferably in excess of 0.6 m.

In order to allow localized welding of the individual grid members in a particularly efficient way, it is advantageous to use unmilled grid members. It has been found, surprisingly, and contrary to current practice that a sufficiently strong bond can be achieved between two stacked grid members if the grid members are welded together at some few contact points only instead of being sintered together over a large area.

In this connection, it has been found advantageous to use grid members that are comprised of structural elevations and depressions and are welded together in the region of their contact points.

Thanks to the elevations provided, the grid members are advantageously joined together at few contact points only. This permits to make welds in a short time using a high current so that the grid structure of the grid members is for the greatest part preserved and is possibly affected in the very area of welding only. As a result, the actual filter function of the filter material is preserved over a large area even after the grid members have been welded together.

Moreover, the elevations make certain that adjacent grid members are spaced a sufficient distance apart and that the grid members do not mutually cover their respective openings, closing each other in the process.

A sufficiently strong bond between the grid members of the filter material is already provided if the filter material has more than one weld joint per 0.5 square cm.

Depending on the structure of the stacked grid members, it is advantageous if the filter element has more than 5 weld joints, preferably more than 20 weld joints, per square cm.

The number of weld joints may be varied particularly easily if at least one grid member has between 5 or 10 and 1500 or 1200 yarns.

In an implementation variant, there is provided that the stacked grid members have differing structures. At least two grid members of different structures that are welded together provide the filter material with particularly good stability.

In a preferred implementation variant there is provided that one grid member is finer than another grid member. Due to its finer structure, the finer grid member forms a kind of filter device of the filter material with the coarser grid member accordingly forming a kind of supporting device of the filter element.

It has been found advantageous if a grid member has openings of more than 5 mm in diameter, preferably of more than 20 mm in diameter, and yarns comprising a diameter in excess of 2 mm. From its structure, such a grid member is particularly well suited to serve as a kind of supporting device.

In order to moreover provide the filter material with good filter properties, it is advantageous to size the openings in the grid member so that they are 5 mm or less, preferably less than 2 mm, in diameter. In some applications, the diameter of the openings can be reduced to 0.005 mm.

A filter material having a coarse grid member is particularly easy to realize if the grid member is an expanded metal.

By contrast, a fabric is particularly well suited for forming the fine grid member of the filter material since it is particularly easy to make openings of less than 2 mm in diameter in a fabric.

In order to manufacture a filter material consisting of a plurality of layers and to thus vary the filter properties, it is advantageous if the filter material is comprised of more than two stacked grid members.

In a particularly preferred implementation variant of a filter material, there is provided that a grid member having a coarser structure be disposed between two grid members showing a finer structure. The grid member with the coarser structure hereby supports the two grid members with the finer structure which results in an overall very rigid filter material. The fine grid members are hereby advantageously made from a fabric and the coarser grid member is preferably an expanded metal.

As a rule, the individual grid members are made from identical materials. It is moreover also possible that the stacked grid members be made from different materials. An expanded metal consists for example of a non corrosive stainless steel and a fabric which is welded to the expanded metal, of a titanium material.

In order to provide a particularly durable bond between stacked grid members of a filter material, more specifically in the side region of the filter material, it is advantageous to provide the filter element with a weld flange. Furthermore, two grid members between the two of which there is disposed, at least in a central region, another grid member are for example held together by the side regions through such a flange. Moreover, a formed filter material is very easy to weld into a filter body by said weld flange.

It is also advantageous if a spacer is disposed between two grid members. A filter material is thus provided that has, at least in some areas, an empty space between the individual grid members. The filter material is thus provided in a simple manner with a certain “volume”, which provides the filter material with particularly good filter properties depending on the field of application.

It is possible that such type spacers are already clamped by the welded grid members. For this purpose, the grid members may be advantageously welded together at their side regions by forming a weld flange.

In order however to reliably prevent the spacers from being displaced, it is advantageous to weld the spacers to the grid members.

A large surface filter material, which is moreover particularly rigid, can be advantageously realized if a filter material is provided with two grid members of a fine structure that are each welded to grid members of a coarser structure and if spacers are disposed between the grid members with the coarser structure.

The filter material is given a clean side border if, in the direction of its longitudinal axis, the filter material is comprised of a sheet metal strip in the border regions.

In order to permit further processing of the filter material in a particularly simple manner, it is advantageous if the sheet metal strip has a width of less than 100 mm, preferably of less than 20 mm. Such a sheet metal strip provides the filter material with additional rigidity.

The filter material can be particularly well welded in the region of the sheet metal strips if the sheet metal strip moreover projects at least partially beyond at least one grid member.

It has been found that a filter material is advantageously processed into a filter body if two sheet metal strips are welded together.

In this context, it is further advantageous if the filter material is provided with a frame. A frame provides the filter material with an advantageous perimeter border so that potential sharp edges can be avoided on the borders of the welded grid members. The risk of injury in particular is thus reduced during further processing of the filter material.

Furthermore, the risk of root penetration in welding a grid member in the area of the frame is thus reduced and, as a result thereof, the probability of undesired formation of a hole in a grid member as well. The same applies of course for areas in which a sheet metal strip overlaps a grid member.

It is particularly advantageous if the frame is disposed at least partially between two grid members. Thus, the frame is at least partially enclosed inside two grid members. As a result, the frame can be bonded to the stacked grid members by a weld joint.

Moreover, the object of the invention is solved by a filter body which is comprised of the filter material described herein above. Since the filter material of the invention has less weld joints than conventional filter materials, the filter material of the invention is particularly convenient to form.

It is particularly advantageous if the filter body is a filter frame, a filter plate, a filter with a U-shaped profile, a filter ring and/or a filter cylinder. As a result, the filter material is very versatile.

Furthermore, the object of the invention is solved by a method of manufacturing a filter material consisting of a plurality of grid members by which the grid members are welded together. Major economical advantages are achieved by welding the grid members into a filter material since bonding of the grid members is much faster using a welding process than using the conventional sintering method.

Particularly profitable manufacturing of the filter material is achieved if the grid members are welded into a continuous length of material. This was hereto before not possible for the known lengths of filter material are produced in sintering furnaces which impose a limitation on the sizing thereof.

In order to achieve during welding a sufficiently good contact between the contact points of the grid members, it is advantageous to press the grid members together at a pressure in excess of 30 bar, preferably in excess of 50 bar, during the welding process. In some application cases, the contact pressure may be raised to above 90 bar.

Furthermore, it has been found advantageous if the grid members are welded with a weld impulse of less than 10 milliseconds or of less than 5 milliseconds, preferably of about 2 milliseconds. A weld impulse of such a short duration is advantageous for the structures of the grid members are substantially preserved over a large area as a result thereof. Advantageously, the structure of the grid members changes only in the immediate region of the welding sites where the material is superficially melted.

To allow for the pressure and moreover the weld current to be applied to the grid members, it is advantageous if the grid members are pressed against each other for welding, using at least one welding die.

In a method variant there is provided that the filter material be provided with metal sheet members and that the metal sheet members are welded together so that the filter material is formed into a cylindrical filter body.

Further advantages, objectives and characteristics of the present invention will become apparent upon reading the description of the appended drawing that illustrates filter materials by way of example.

In the drawings

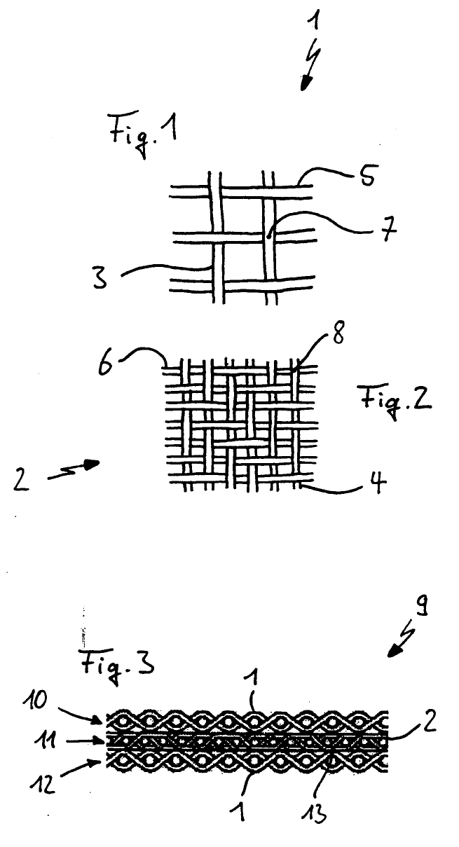

FIG. 1 shows a grid member comprising relatively coarse warp and weft yarns as well as a relatively coarse mesh width.

FIG. 2 shows another grid member that is comprised of finer warp and weft yarns as well as of a smaller mesh width than the first grid member of FIG. 1,

FIG. 3 is a schematic cross-sectional view of a three-layered filter material consisting of different grid members,

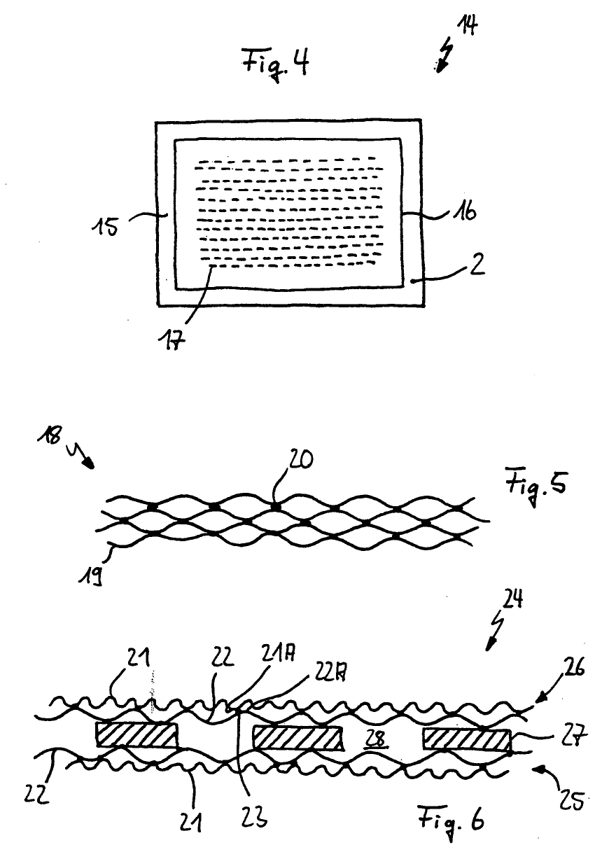

FIG. 4 is a schematic top view of a length of filter material with a flange,

FIG. 5 is a schematic cross-sectional view of a four-layered filter material having identical grid members,

FIG. 6 is a schematic cross-sectional view of another four-layered filter material having spacers,

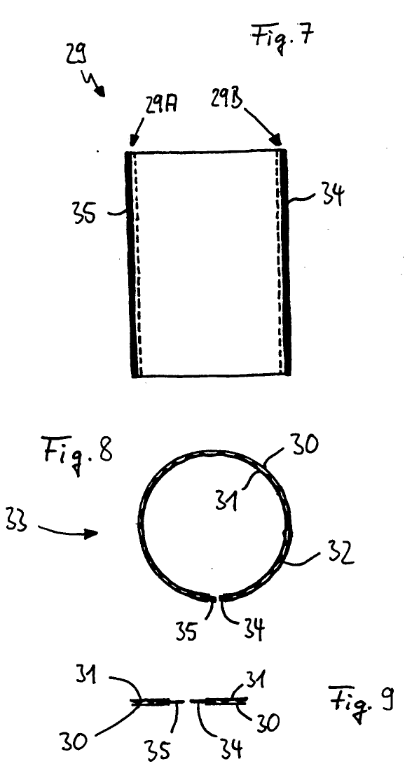

FIG. 7 is a schematic side view of a filter cylinder made of a two-layered filter material having a laterally disposed sheet metal strip,

FIG. 8 is a schematic top view of the filter cylinder of FIG. 7 and

FIG. 9 is a schematic detail view of the abutting sheet metal strips of the filter cylinder of the FIGS. 7 and 8.

The FIGS. 1 and 2 each show a grid member 1 and 2 respectively consisting of a plurality of warp yarns 3 and 4 and of a plurality of weft yarns 5 and 6.

The yarns 3 and 5 of grid member 1 have a larger diameter and are moreover more densely interwoven so that the grid member 1 has a substantially coarser mesh width than grid member 2.

Both grid members 1 and 2 are unmilled so that the grid members 1 and 2 show elevations at what are termed the “intersection points” 7 and 8 (only numbered once herein by way of example) as compared to the other regions of the grid members 1 and 2. If the grid members 1 and 2 are planarly placed on top of each other, they will substantially touch each other only in the regions of their intersection points 7 and 8 by which they may then be advantageously welded together to form a filter material 9 (see FIG. 3).

In this exemplary embodiment, the filter material 9 consists of three stacked grid members 1 and 2 with one coarser grid member 1 being attached to the finer grid member 2 on either side thereof respectively.

The filter material 9 is thus provided with a robust protective layer 10 behind which the actual filter layer 11 is disposed. In order to moreover provide the filter material 9 with very good stability, a draining layer 12 is additionally disposed on the filter layer 11 so that the finer filter layer 11 is sandwiched between the protective layer 10 on the one side and the draining layer 12 on the other side.

As the grid members 1 and 2 are not milled, the individual layers 10, 11 and 12 are not lying flat on top of each other so that the layers 10 and 12 are joined together at some few contact points only (numbered herein by way of example only).

As the individual layers 10, 11 and 12 are contacting each other at some few contact points 13 only, the layers 10, 11 and 12 can be bonded together by welding since the grid members are melted superficially at the few contact points 13 only and lose their actual structure only there.

In contrast to prior opinion it was found out that, in order to obtain a robust filter material 9, it is sufficient to weld various grid members 1 and 2 together at some few contact points 13.

On the one hand, the filter material 9 welded in accordance with the invention permits to save one milling procedure for each of the grid members 1 and 2 over conventional sintering methods. In conventional manufacturing methods, milling is necessary for the purpose of obtaining the wide large-surface contact area between the individual grid members 1 and 2 required for sintering.

On the other hand, in contrast to conventional filter material, the filter material 9 of the invention may be manufactured in the form of a continuous length of material and is less expensive to manufacture than conventional filter material which is manufactured by sintering.

The filter material segment 14 shown in FIG. 4 consists of two fine grid members 2 with a coarser grid member 1 sandwiched therein between. In this exemplary embodiment, the coarser grid member 1 is configured to be smaller than the two fine grid members 2 so that the two fine grid members 2 directly abut each other in their border region 15 where they are welded together over the entire perimeter in a linear manner by means of a flange 16. Such an arrangement allows for the filter material segment 14 to have a flat border in the border region 15.

The coarser grid member 1 is welded to the finer grid members 2 by a plurality of welds 17 so that the individual grid members 1 and 2 are very intimately bonded to form a compact filter material segment 14.

The filter material 18 shown in FIG. 5 substantially consists of four identical grid members 19 that are stacked upon each other. The grid member 19 hereby is sinusoidal in cross-sectional shape so that the grid members 19 are substantially welded together in the region of their elevations 20. The filter material 18 thus obtained is welded at only a few contact points 13 (see FIG. 3) without the structure of the grid members 19 being excessively affected by the welding process. The material of the grid members 19 is only superficially melted in the region of the welded elevations 20 so that the individual grid members 1 and 2 are bonded together at these sites.

In FIG. 6, grid structures 21 and 22 of different thicknesses are bonded to elevations 21A and 22A by means of weld joints 23. Accordingly, weld joints 23 occur only in the regions in which the elevations 21A and 22A touch each other. The thus manufactured filter material 24 consists of altogether four grid members 21 and 22. In this exemplary embodiment, a respective one of the grid members 21 and 22 forms a filter material layer 25 and 26 and the filter material layers 25 and 26 are separated by spacers 27 (numbered herein by way of example only). As a result, there is an empty space 28 between the individual filter material layers 25 and 26. On their elevations 22A, the grid members 22 within the filter material 24 are bonded to the spacer 27 by a weld joint.

The filter material segment 29 shown in FIG. 7 consists of a fine grid member 30 and of a coarser grid member 31 (see FIG. 8). The finer grid member 30 is a fabric and the coarser grid member 31, an expanded metal. The two grid members 30 and 31 are welded together at raised regions 32.

The filter material segment 29 is formed into a filter cylinder 33. For this purpose, the lateral border regions 29A and 29B of the filter material segment 29 are each provided with a sheet metal strip 34 and 35 by which the filter material segment 29 may be welded in a particularly simple constructional manner to form a filter cylinder 33.

The sheet metal strips 34 and 35 are disposed between the welded-together grid members 30 and 31 so that, on the one hand, the two sheet metal strips 34 and 35 can be bonded together by means of a butt-weld seam and that, on the other hand, the filter material segment 29 is comprised of a smooth border at least in the border regions 29A and 29B.

A filter cylinder 33 manufactured according to this principle is particularly well suited for widening the initial diameter of the filter cylinder 33 at a later stage. In operation, the filter cylinder 33 may thus be adapted in a very simple manner to the changing conditions of utilization. Such an application lies in the field of what is termed “Sand Control Sking”.

1. A filter material (9; 18; 24) consisting of two stacked grid members (1; 2; 30, 31) characterized in that the grid members (1; 2; 30, 31) have a weld joint (23) between them.

2. The filter material (9; 18; 24) according to claim 1, characterized in that the grid members (1; 2; 30, 31) are unmilled.

3. The filter material (9; 18; 24) according to one of the claims 1 or 2, characterized in that the grid members (1; 2; 30, 31) have structural elevations (20; 21A; 22A) and depressions and are bonded together in the region of their contact points (20; 21A; 22A).

4. The filter material (9; 18; 24) according to one of the claims 1 through 4, characterized in that the filter material (9; 18; 24) has more than one weld joint (23) per 0.5 square cm.

5. The filter material (9; 18; 24) according to one of the claims 1 through 5, characterized in that the filter material (9; 18; 24) has more than 5 weld joints (23), preferably more than 20 weld joints (23), per 1.0 square cm.

6. The filter material (9; 18; 24) according to one of the claims 1 through 5, characterized in that at least one grid member has between 5 or 10 and 1500 or 1200 yarns per cm.

7. The filter material (9; 18; 24) according to one of the claims 1 through 6, characterized in that the stacked grid members (1; 2; 30, 31) have differing structures.

8. The filter material (9; 18; 24) according to one of the claims 1 through 7, characterized in that one grid member (1; 2; 30, 31) is finer than another grid member (1; 2; 30, 31).

9. The filter material (9; 18; 24) according to one of the claims 1 through 8, characterized in that one grid member (1; 2; 30, 31) has openings of more than 5 mm in diameter, preferably of more than 20 mm in diameter.

10. The filter material (9; 18; 24) according to one of the claims 1 through 9, characterized in that one grid member (1; 2; 30, 31) has openings of 5.0 mm or less, preferably of less than 2.0 mm in diameter.

11. The filter material (9; 18; 24) according to one of the claims 1 through 10, characterized in that one grid member (1; 2; 30, 31) is a fabric (30).

12. The filter material (9; 18; 24) according to one of the claims 1 through 11, characterized in that one grid member (1; 2; 30, 31) is an expanded metal (31).

13. The filter material (9; 18; 24) according to one of the claims 1 through 12, characterized in that a grid member (1; 2; 30, 31) with a coarser structure is disposed between two grid members (1; 2; 30, 31) having a finer structure.

14. The filter material (9; 18; 24) according to one of the claims 1 through 13, characterized in that the filter material (9; 18; 24) is comprised of more than two stacked grid members (1; 2; 30, 31).

15. The filter material (9; 18; 24) according to one of the claims 1 through 14, characterized in that the stacked grid members (1; 2; 30, 31) are made from different materials.

16. The filter material (9; 18; 24) according to one of the claims 1 through 15, characterized in that the filter material (9; 18; 24) comprises a weld flange (16).

17. The filter material (9; 18; 24) according to one of the claims 1 through 16, characterized in that spacers (27) are disposed between two grid members (1; 2; 30, 31).

18. The filter material (9; 18; 24) according to one of the claims 1 through 17, characterized in that the spacers (27) are welded to the grid members (1; 2; 30, 31).

19. The filter material (9; 18; 24) according to one of the claims 1 through 18, characterized in that a filter material (9; 18; 24) is comprised of two grid members (1; 2; 30, 31) with a fine structure that are each welded to grid members (1; 2; 30, 31) having a coarser structure and that spacers (27) are disposed between the grid members (1; 2; 30, 31) having the coarser structures.

20. The filter material (9; 18; 24) according to one of the claims 1 through 19, characterized in that, in the border regions (29A, 29B), the filter material (9; 18; 24) is comprised of a sheet metal strip (34, 35) in the direction of its longitudinal axis.

21. The filter material (9; 18; 24) according to claim 20, characterized in that the sheet metal strip (34, 35) is less than 100 mm, preferably less than 20 mm, wide.

22. The filter material (9; 18; 24) according to one of the claims 20 or 21, characterized in that the sheet metal strip (34, 35) projects at least partially beyond at least one grid member (1; 2; 30, 31).

23. The filter material (9; 18; 24) according to one of the claims 20 through 22, characterized in that two sheet metal strips (34, 35) are welded together.

24. The filter material (9; 18; 24) according to one of the claims 1 through 23, characterized in that the filter material (9; 18; 24) comprises a frame.

25. The filter material (9; 18; 24) according to claim 24, characterized in that the frame is at least partially disposed between two grid members (1; 2; 30, 31).

26. A filter body, characterized in that the filter body comprises a filter material (9; 18; 24) according to one of the claims 1 through 24.

27. The filter body according to claim 26, characterized in that the filter body is a filter frame, a filter plate, a filter with a U-shaped profile, a filter ring or a filter cylinder (33).

28. A method of manufacturing a filter material (9; 18; 24) consisting of several grid members (1; 2; 30, 31), characterized in that the method comprises welding the grid members (1; 2; 30, 31) together.

29. The method according to claim 28, characterized in that the method comprises welding the grid members (1; 2; 30, 31) together to form a continuous length of material.

30. The method according to claim 28 or 29, characterized in that the grid members (1; 2; 30, 31) are pressed together at a pressure in excess of 30 bar, preferably in excess of 50 bar, during the welding process.

31. The method according to one of the claims 28 through 30, characterized in that the grid members (1; 2; 30, 31) are welded with a weld impulse of less than 10 milliseconds or of less than 5 milliseconds, preferably of about 2 milliseconds.

32. The method according to one of the claims 28 through 31, characterized in that, for welding, the grid members (1; 2; 30, 31) are pressed against each other using at least one welding die.

33. The method according to one of the claims 28 through 32, characterized in that the filter material (9; 18; 24) is provided with sheet metal elements and that the sheet metal elements are welded together so that the filter material (9; 18; 24) yields a cylindrical filter body.
